(19) United States
(12) Patent Application Publication
(10) Pub. No.: US 2020/0248432 A1
(43) Pub. Date: Aug. 6, 2020

(54) Operating Device Of Construction Machine

(71) Applicant: Caterpillar SARL, Geneva (CH)

(72) Inventors: Eiji AKAHANE, Akashi-shi (JP); Naoya OKADA, Akashi-shi (JP)

(73) Assignee: Caterpillar SARL, Geneva (CH)

(21) Appl. No.: 16/636,488

(22) PCT Filed: Aug. 22, 2018
(86) PCT No.: PCT/EP2018/072701

§ 371 Date: Feb. 4, 2020

(30) Foreign Application Priority Data
Aug. 23, 2017 (JP) 2017-160404

(51) Int. Cl. E02F 9/20; G05G 5/00; G05G 9/047

(52) U.S. Cl. CPC E02F 9/2004; G05G 2505/00; G05G 9/047; G05G 5/005

(57) ABSTRACT

Provided is an operating device for a construction machine that prevents an operator from accidentally gripping the blocking bar when the operator walks through the passage in front of the console box and that also prevents work clothes of the operator from being caught in the blocking bar. An operating device for a construction machine includes: a console box having an operating lever attached to an upper surface thereof, wherein the operating lever outputs a signal for operating the construction machine in response to a manual operation; and a blocking bar that is swingably attached to the console box about an axis extending widthwise between a block position at which to block a passage provided in front of the console box and a retreat position at which the blocking bar retreats from the passage. A recess is formed in a front end of a lateral side of the console box. The blocking bar is housed in the recess when it is positioned at the retreat position.

### TECHNICAL FIELD

The present invention relates to an operating device of a construction machine, the operating device including: a console box having an operating lever attached to an upper surface of the console box, wherein the operating lever outputs a signal for operating the construction machine in response to a manual operation; and a blocking bar that is swingably attached to the console box between a block position at which a passage provided in front of the console box is blocked and a retreat position at which the blocking bar retreats from the passage.

### BACKGROUND ART

In general, an operating device of a construction machine disposed in a cab of a hydraulic shovel and other construction machines includes a console box having an operating lever attached to an upper surface of the console box, wherein the operating lever outputs a signal for operating the construction machine in response to a manual operation and a blocking bar that is swingably attached to the console box between a block position at which a passage provided in front of the console box is blocked and a retreat position at which the blocking bar retreats from the passage. A means for detecting whether or not the blocking bar rests at the block position is also attached to the console box. The detection means is configured to output an operation signal from the operating lever to a control means of the construction machine in response to a manual operation applied to the operating lever if the detection means detects that the blocking bar rests at the block position, and otherwise to output no operation signal from the operating lever to the control means of the construction machine. A thus configured operating device of a construction machine allows an operator to walk through the passage in front of the console box and outputs no operation signal from the operating lever to the control means when the blocking bar is positioned at the retreat position, which can prevent a wrong operation that might be caused by the operator accidentally touching the operating lever when the operator walks through the passage in front of the console box. In addition, in the operating device of a construction machine described above an operation signal may be output from the operating lever to the control means when the blocking bar is positioned at the block position. As a result, the operating device allows the construction machine to be operated with the operating lever while disallowing the operator to walk through the passage in front of the console box, which can prevent the wrong operation of the construction machine (see, for example, Patent Literature 1).

### CITATION LIST

### Patent Literature

Patent Literature 1: JP 2008-25141 A

### SUMMARY OF INVENTION

### Technical Problem

For the blocking bar disclosed in Patent Literature 1, an operator might accidentally grip the blocking bar, or work clothes of the operator might be caught in the blocking bar when the operator walks through the passage in front of the console box. The blocking bar might possibly be damaged on such occasions.

The present invention made in view of the above facts aims to provide an operating device of a construction machine that prevents the operator from accidentally gripping the blocking bar when the operator walks through the passage in front of the console box and that also prevents work clothes of the operator from being caught in the blocking bar.

### Solution to Problem

In order to solve the above problems, the present invention provides the following operating device of a construction machine. That is to say, an operating device including a console box having an operating lever for outputting a signal for operating the construction machine in response to a manual operation attached to an upper surface of the console box and a blocking bar that is attached to the console box and is swingable about an axis extending in a width direction of the construction machine between a block position at which a passage provided in front of the console box is blocked and a retreat position at which the blocking bar retreats from the passage, wherein a recess is formed on a front end of a lateral surface of the console box, and the blocking bar is housed in the recess when it is positioned at the retreat position.

Preferably, a surface of the blocking bar and an external surface of the console box adjacent to the recess are flush when the blocking bar is housed in the recess. It is preferred that at least a base end portion of the blocking bar is formed of a hard member, while at least a distal end portion of the blocking bar is formed of a soft member that is more elastically deformable than the hard member. Advantageously, a guided opening is formed in a widthwise intermediate portion of a lower end of the blocking bar that rests at the block position, a guiding protrusion is provided in the recess of the console box that tapers from its base end to distal end, and the guiding protrusion is inserted into the guided opening when the blocking bar is swung from the block position to the retreat position, thereby forcing a widthwise position of the blocking bar. Preferably formed at the distal end portion of the blocking bar is a surface that slopes down outward widthwise when the blocking bar rests at the block position. It is preferred that the console box is provided with a manual knob for swinging the blocking bar between the block position and the retreat position, and a means for decelerating the blocking member immediately before the retreat position when the blocking bar is swung by the manual knob from the block position toward the retreat position.

### Advantageous Effects of Invention

In the operating device of a construction machine provided by the present invention, the blocking bar is housed in the recess of the console box when it is positioned at the retreat position, so that an operator will never accidentally grip the blocking bar when the operator walks through the passage in front of the console box, and nor will work clothes of the operator be caught in the blocking bar, which in turn prevents the blocking bar from being damaged.

### BRIEF DESCRIPTION OF THE DRAWINGS

FIG. 1 is a side view of a cab including an operating device of a construction machine configured according to the present invention.

FIG. 2 is a side view of an operating device of a construction machine where the blocking bar shown in FIG. 1 is placed in a block position.

FIG. 3 is a perspective view of an operating device of a construction machine where the blocking bar shown in FIG. 1 is placed in a block position.

FIG. 4 is a side view of an operating device of a construction machine where the blocking bar shown in FIG. 1 is placed in a retreat position.

FIG. 5 is a perspective view of an operating device of a construction machine where the blocking bar shown in FIG. 1 is placed in a retreat position.

FIG. 6 is a perspective view of the blocking bar shown in FIG. 1 being seen from a rear side.

FIG. 7 is a cross-sectional view taken along line A-A of FIG. 4

FIG. 8 is a cross-sectional view taken along line B-B of FIG. 4.

FIG. 9 is a perspective view of a manual knob and a blocking bar where the blocking bar shown in FIG. 1 is placed in a retreat position.

FIG. 10 is a perspective view of a manual knob and a blocking bar where the blocking bar shown in FIG. 1 is placed in a block position.

FIG. 11 is a perspective view of a console box whose front plate member is removed.

FIG. 12 is a perspective view of a console box whose front plate member is attached.

### DESCRIPTION OF THE EMBODIMENTS

An embodiment of an operating device of a construction machine configured according to the present invention will be hereinafter described with reference to the drawings.

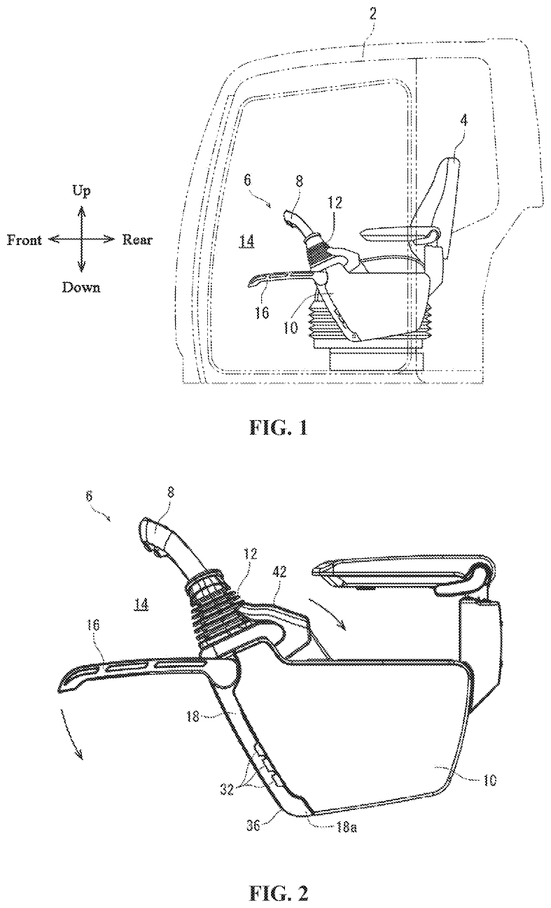

FIG. 1 shows a cab 2 mounted on a construction machine such as a hydraulic shovel. A driver seat 4 and an operating device 6 are disposed inside the cab 2. The operating device 6 is attached to the left and right sides of the driver seat 4 (only the left operating device 6 is illustrated). The operating device 6 includes a console box 10 having operating lever 8 attached to an upper surface thereof. The operating lever 8 outputs a signal for operating a construction machine in response to a manual operation. The operating lever 8 may be connected to a control means (not shown) for controlling the operation of the construction machine with an electric wire or a hydraulic conduit, and output from the operating lever 8 to the control means an operation signal made up of an electrical signal or a hydraulic signal corresponding to the manual operation applied to the operating lever 8. A lower end side of the operating lever 8 is covered by a generally frustoconical bellows boot 12, which may be formed of suitable resilient material such as synthetic rubber. Note that in the present specification, the front side of the FIG. 1 page will be regarded as the left side, while and the rear side thereof will be regarded as the right side. In addition, the vertical and anteroposterior directions indicated in FIG. 1 by the letters “up”, “down”, “front”, and “rear”, and arrows are the respective directions in the present specification.

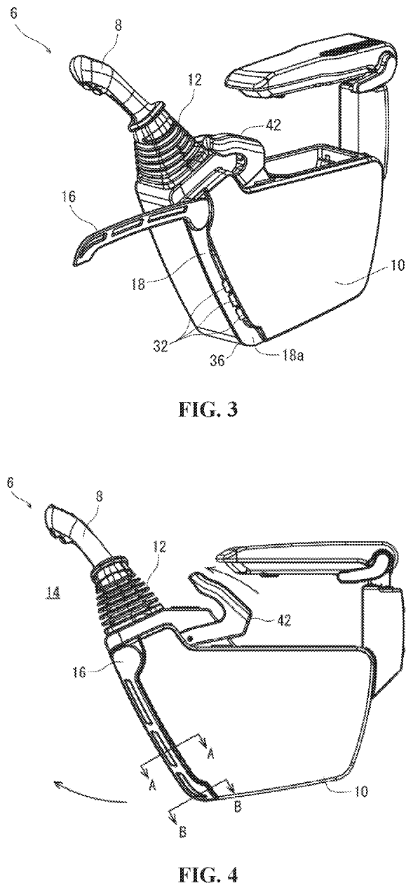

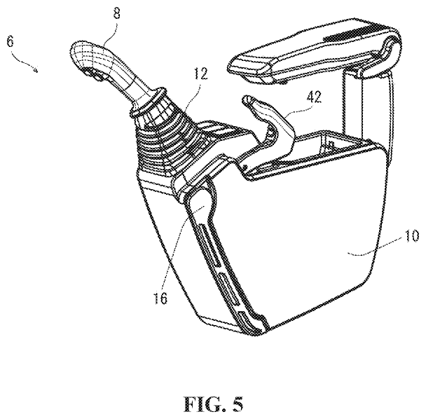

In the illustrated embodiment, a passage 14 through which an operator enters and exits the cab 2 is provided in front of the left operating device 6, as shown in FIG. 1. In other words, a door (not shown) is provided on the left side of the cab 2 in the illustrated embodiment, which enables the operator to open a door and enter/exit the cab 2 through the passage 14. In addition, a base end portion of the blocking bar 16, which can block the passage 14, is swingably attached, about an axis extending widthwise, to an upper front end of a lateral side of the console box 10 (a lateral side that is distal from the driver seat 4) of the left operating device 6. Referring to FIGS. 2 to 5, the blocking bar 16 is configured to swing between a block position (shown in FIGS. 2 and 3) at which the blocking bar 16 protrudes ahead of the console box 10 to block the passage 14 and a retreat position (shown in FIGS. 4 and 5) at which the blocking bar extends along the front end of the console box 10 to retreat from the passage 14. As shown in FIGS. 2 and 3, a recess 18 is formed at a front end of a lateral side of the console box 10 (a lateral side that is distal from the driver seat 4). The recess 18 slopes backward from an upper end to a lower end along the front end of the lateral side of the console box 10. In the operating device 6 configured according to the present invention, it is important that the blocking bar 16 be housed in the recess 18 of the console box 10 when the blocking bar 16 positioned at the retreat position, as shown in FIGS. 4 and 5. The recess 18 corresponds in shape to the blocking bar 16. An exposed surface of the blocking bar 16 and an external surface of the console box 10 adjacent to the recess 18 are preferably flush when the blocking bar 16 is housed in the recess 18.

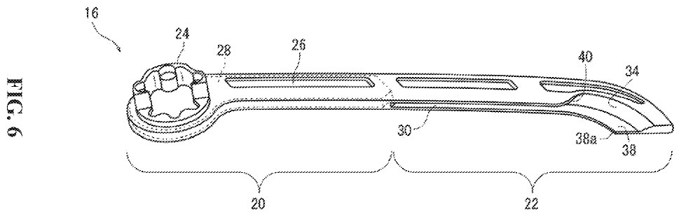

Now material of the blocking bar 16 will be described with reference to FIG. 6. Preferably, at least the base end portion of the blocking bar 16 is formed of a hard member, while at least the distal end portion of the blocking bar 16 is formed of a soft member that is more elastically deformable than the hard member. In the illustrated embodiment, a base end portion 20 extending from the base end portion to an intermediate portion of the blocking bar 16 is formed of a hard member, while a distal end portion 22 extending from the intermediate part to the distal end portion thereof is formed of a soft member, as shown in FIG. 6. A hard nylon containing glass fiber is available as the hard member. An elastomer (e.g., polyester thermoplastic elastomer) is available as the soft member. The fact that at least the base end portion of the blocking bar 16 is formed of the hard member may make it possible to configure a connection portion 24 for swingably connecting the blocking bar 16 to the console box 10. The distal end portion 22 of the blocking bar 16 is formed of the soft member that is more elastically deformable than the hard member, which allows the operator to push the distal end portion 22 of the blocking bar 16 away and escape from the cab 2. Note that, the base end portion 20 excluding the connection portion 24, which is connected to the console box 10, may be partially or entirely covered by the soft member. For example, a part indicated by a reference numeral 28, a part excluding the connection portion 24 and a parallelogram indicated by reference numeral 26 on a rear side of the blocking bar 16, may be covered by the soft member, as shown in FIG. 6.

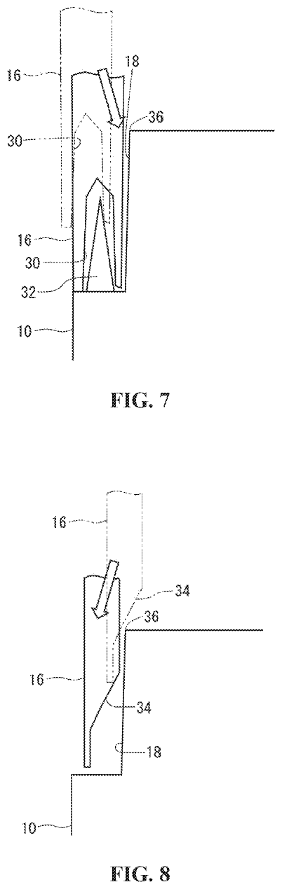

When the blocking bar 16 rests at a block position at which the same extends in the anteroposterior direction, as shown in FIG. 6, a guided opening 30 extending from an anteroposterior intermediate portion toward the distal end is advantageously formed in a widthwise intermediate portion of the lower end thereof. In the illustrated embodiment, the recess 18 of the console box 10 is provided with a guiding protrusion 32 that tapers from the base end toward the distal end, as shown in FIGS. 2 and 3. When the blocking bar 16 is swung from the block position to the retreat position about an axis extending widthwise, a guiding protrusion 32 is inserted into the guided opening 30 of the blocking bar 16, thereby forcing a widthwise position of the blocking bar 16, as shown in FIG. 7. For example, as shown by two-dot chain line in FIG. 7, on an occasion when the blocking bar 16 warps outward widthwise, the guiding protrusion 32 is inserted into the guided opening 30 of the blocking bar 16 immediately before the retreat position, which forces the blocking bar 16 inward widthwise, thereby housing the blocking bar 16 in the recess 18 with the blocking bar 16 being forcibly placed in a predetermined widthwise position. In addition, on an occasion when the blocking bar 16 warps inward widthwise, the guiding protrusion 32 is inserted into the guided opening 30 of the blocking bar 16 immediately before the retreat position, which forces the blocking bar 16 outward widthwise, thereby housing the blocking bar 16 in the recess 18 with the blocking bar 16 being forced at a predetermined widthwise position. While the blocking bar 16 is housed in the recess 18, the guiding protrusion 32 restrains the blocking bar 16 from swaying widthwise during transportation of the construction machine or on other occasions. Although the recess 18 is provided with three guiding protrusions 32 in the illustrated embodiment, it may be provided with at least one guiding protrusion 32.

As shown in FIGS. 6 and 8, preferably formed at the distal end portion of the blocking bar 16 is a slope surface 34, which slopes down outward widthwise when the blocking bar 16 rests at the block position. On an occasion when the blocking bar 16 warps inward as shown by a two-dot chain line in FIG. 8, the slope surface 34 formed on the distal end portion of the blocking bar 16 comes into contact with a boundary 36 of the recess 18 immediately before the retreat position, forcing the distal end portion of the blocking bar 16 outward widthwise. This houses the blocking bar 16 in the recess 18 with the distal end portion of the blocking bar 16 being forcibly placed in a predetermined widthwise position.

As in the illustrated embodiment, an additional recess 18a (see FIG. 2), which is further recessed rearward at a lower end of recess 18 of the console box 10, is formed. On an occasion when a protrusion 38 is formed on the distal end portion of the blocking bar 16 housed in the additional recess 18a at the retreat position, a notch 40 is desirably formed on a rear side of the protrusion 38 as shown in FIG. 6. Otherwise a rear part of an apex 38a of the protrusion 38 may possibly collide with the boundary 36 of the recess 18 and be damaged at a time when the protrusion 16 is swung from the block position to the retreat position if the blocking bar 16 warps inward widthwise. If the notch 40 is formed on the rear side of the protrusion 38 in the above occasion, however, a rear part of the apex 38a of the protrusion 38 avoids colliding with the boundary 36 of the recess 18 and being damaged at the time when the protrusion 16 is swung from the block position to the retreat position even if the blocking bar 16 warps inward widthwise.

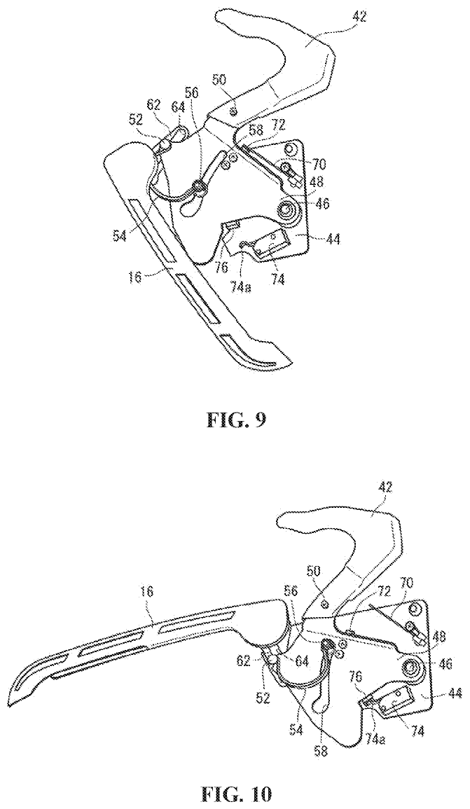

In the illustrated embodiment, the console box 10 is provided with a manual knob 42 for swinging the blocking bar 16 between the block position and the retreat position as shown in FIGS. 2 to 5. Applying a manual operation to the manual knob 42 clockwise viewed from the widthwise outside while the blocking bar 16 rests at the block position shown in FIG. 2 swings the blocking bar 16 counterclockwise, viewed the widthwise outside, from the block position toward the retreat position. On the other hand, applying a manual operation to the manual knob 42 counterclockwise viewed from the widthwise outside while the blocking bar 16 rests at the retreat position shown in FIG. 4 swings the blocking bar 16 clockwise, viewed the widthwise outside, from the retreat position toward the block position. In other words, the blocking bar 16 is configured to swing in a direction opposite to a direction of the manual operation applied to the manual knob 42. A swing mechanism of the blocking bar 16 including such manual knob 42 will be now described with reference to FIGS. 9 to 11. As shown in FIGS. 9 and 10, a support plate 44 extending in the vertical direction is fixed to the inside of the console box 10. A swing plate 48 is swingably attached to a rear part of the support plate 44 via a connecting pin 46. A lower part of the manual knob 42 is connected to an upper part of the swing plate 48 with a screw 50. A transmission pin 52 that penetrates through the swing plate 48 and protrudes from a front surface and a rear surface of the swing plate 48 is fixed to a front part of the swing plate 48. One end of a semi-annular plate spring 54 is connected to the transmission pin 52. The other end of the plate spring 54 is connected to a fixing pin 56, which penetrates through the swing plate 48 and is fixed to the support plate 44. A long hole 58 is formed on the swing plate 48 for preventing the fixing pin 56 from inhibiting the swing plate 48 from swinging. As shown in FIG. 11, a transmission piece 62 is attached to an upper part of a front end of the support plate 44 via a connecting pin 60. As shown in FIGS. 9 and 10, a long hole 64 is formed on the transmission piece 62, and the transmission pin 52 of the swing plate 48 is inserted into the long hole 64. In addition, a connecting piece (not shown) to which a connection portion 24 of the blocking bar 16 is connected is fixed to the transmission piece 62 by a plurality of screws 66 (see FIG. 11), and the blocking bar 16 is fixed with two screws 68 to the connecting piece fixed by the transmission piece 62.

Swinging the blocking bar 16 from the retreat position to the block position requires a manual operation to be applied to the manual knob 42 counterclockwise from the widthwise outside. Then the swing plate 48 connected to the manual knob 42 swings about the connection pin 46, and in turn the transmission pin 52 fixed to the front part of the swing plate 48 moves while pressing the transmission piece 62. Thus, the manual operation force applied to the manual knob 42 is transmitted to the transmission piece 62, which swings the blocking bar 16 swings clockwise from the widthwise outside along with the transmission piece 62. As described above, in the illustrated embodiment, applying a manual operation to the manual knob 42 counterclockwise viewed from the widthwise outside while the blocking bar 16 rests at the retreat position shown in FIG. 4 swings the blocking bar 16 clockwise, viewed the widthwise outside, from the retreat position toward the block position.

As will be understood by reference to FIGS. 9 and 10, the blocking bar 16 is urged by the semi-annular plate spring 54 toward the block position or the retreat position via the transmission pin 52 and the transmission piece 62. The blocking bar 16 is therefore kept resting at the block position or the retreat position by the plate spring 54 unless a manual operation with a force exceeding the urging force of the plate spring 54 is applied to the manual knob 42. The urging force applied by the plate spring 54 acts such that the blocking bar 16 swings toward the block position on an occasion when the blocking bar 16 rests at a position that is closer to the block position than to an intermediate portion between the block position and the retreat position, and toward the retreat position on an occasion when the blocking bar 16 rests at a position that is closer to the retreat position than to an intermediate portion between the block position and the retreat position. Hence swinging the blocking bar 16 requires a manual operation with a force exceeding the urging force of the plate spring 54 to be applied to the manual knob 42 until the blocking bar 16 passes at least through the intermediate portion between the block position and the retreat position. Once the blocking bar 16 passes through the intermediate portion between the block position and the retreat position, the blocking bar 16 will continue to swing by virtue of the urging force of the plate spring 54, even if the manual operation applied to the manual knob 42 is released.

The console box 10 is preferably provided with a means for decelerating the blocking bar 16 immediately before the retreat position at a time when the blocking bar 16 is swung by the manual knob 42 from the block position toward the retreat position. In the illustrated embodiment, the deceleration means consists of a plate spring 70 supported by the support plate 44, as shown in FIGS. 9 and 10. In addition, a deceleration protrusion 72 that comes into contact with the plate spring 70 in the immediate front of the retreat position is attached to the swing plate 48.

When the manual knob 42 is manually operated clockwise from the widthwise outside in order to swing the blocking bar 16 from the block position to the retreat position, the swing plate 48 swings and the transmission pin 52 moves while pressing the transmission piece 62. Thus, the manual operation force applied to the manual knob 42 is transmitted to the transmission piece 62, which swings the blocking bar 16 swings counterclockwise from the widthwise outside along with the transmission piece 62. The deceleration protrusion 72 comes in contact with the plate spring 70 immediately before the blocking bar 16 reaches the retreat position, and then the urging force of the plate spring 70 acts on the swing plate 48 swinging clockwise from the widthwise outside in a direction opposite to a swing direction of the swing plate 48 (i.e., counterclockwise from the widthwise outside). Thus, the swing plate 48 decelerates, and in turn the blocking bar 16 decelerates immediately before the retreat position. This prevents the blocking bar 16 from being damaged or making a collision noise caused by a vigorous collision of the blocking bar 16 and the console box 10 at a time when the blocking bar 16 swings up to the retreat position and is housed in the recess 18 of the console box 10. The plate spring 70 constituting the deceleration means is set to have an urging force that is smaller than the half-annular plate spring 54. The blocking bar 16, hence, decelerates immediately before the retreat position, but swings toward the retreat position by virtue of the urging force of the semi-annular plate spring 54 until it is housed in the recess 18 of the console box 10.

As shown in FIGS. 9 and 10, a detector 74 connected to the control means is fixed to the support plate 44. In addition, the swing plate 48 is provided with a detection protrusion 76 that is in contact with a detection piece 74a of the detector 74 in a circumstance where the swing plate 16 rests at the block position. In a circumstance where the blocking bar 16 rests at the retreat position as shown in FIG. 9, the detector 74 fails to detect that the blocking bar 16 rests at the block position because the detection protrusion 76 of the swing plate 48 is out of touch with the detection piece 74a of the detector 74. In this circumstance, the operating lever 8 outputs no operation signal to the control means even if the operating lever 8 is manually operated, thereby preventing a wrong operation of the construction machine. When the blocking bar 16 is placed at the block position, on the other hand, the detector 74 detects that the blocking bar 16 rests at the block position because the detection protrusion 76 of the swing plate 48 comes into contact with the detection piece 74a of the detector 74. In this circumstance, the operating lever 8 outputs the operation signal to the control means in accordance with a manual operation applied to the operating lever 8, so that the construction machine can be operated with the operating lever 8.

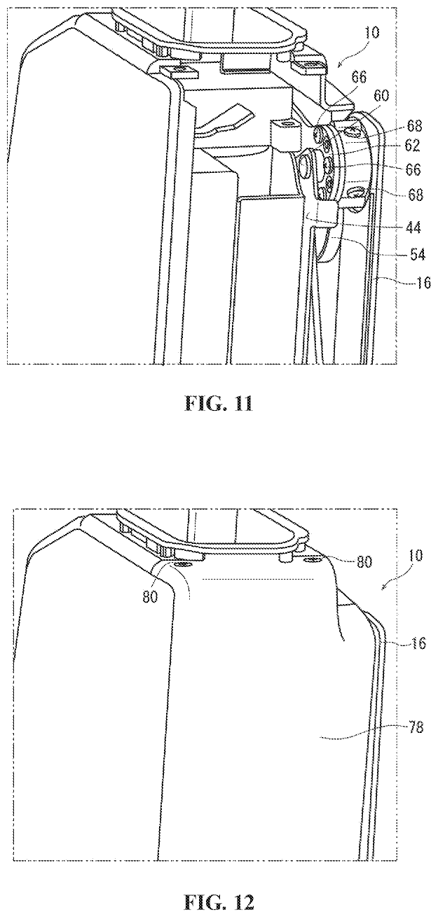

As shown in FIG. 12, a plate member 78 forming a front wall of the console box 10 is fixed with two screws 80 disposed on an upper end of the plate member 78 and is removably configured. In an assembled operating device 6 shown in FIG. 2 or 5, the two screws 80 are covered by a bellows boot 12. Turning up the bellows boot 12, loosening the two screws 80, and removing the plate member 78 of the console box 10 enables easy access to a screw 68 for fastening the blocking bar 16.

As described above, the blocking bar 16 is housed in the recess 18 of the console box 10 when it is positioned at the retreat position in the illustrated embodiment, so that an operator will never accidentally grip the blocking bar 16 when the operator walks through the passage 14 in front of the console box 10, and nor will work clothes of the operator be caught in the blocking bar 16, which in turn prevents the blocking bar 16 from being damaged. In addition, a surface of the blocking bar 16 housed in the recess 18 is flush with an external surface of the console box 10 adjacent to the recess 18 in the illustrated embodiment, which is expected to offer better external appearance.

The illustrated embodiment describes an example of the deceleration means for decelerating the blocking bar 16 immediately before the retreat position where the deceleration means is constituted by the plate spring 70 that comes into contact with the deceleration protrusion 72 of the swing plate 48 immediately before the retreat position, but the deceleration means is not limited to the configuration described above, but may be constituted, for example, by an elastic member disposed at an end of the long hole 58 of the swing plate 48. In other words, the elastic member disposed at the end of the long hole 58 may come into contact with the fixing pin 56 of the support plate 44 immediately before the blocking bar 16 reaches the retreat position to decelerate the swing of the swing plate 48, thereby decelerating the blocking bar 16. Although the illustrated embodiment does not particularly refer to how the console box 10 is postured, the console box 10 is configured to be swingable about an axis extending widthwise at a lower portion of a rear end of the console box 10 and to jump backward by virtue of a manual operation applied to the manual knob 42.

### REFERENCE SIGNS LIST

6: Operating device

8: Operating lever

10: Console box

14: Passage

16: Blocking bar

18: Recess

30: Guided opening

32: Guiding protrusion

34: Slope

42: Manual knob

70: Plate spring (deceleration means)

1. An operating device of a construction machine, the operating device comprising:
a console box having an operating lever attached to an upper surface of the console box, wherein the operating lever outputs a signal for operating the construction machine in response to a manual operation to be applied; and
a blocking bar that is swingably attached to the console box about an axis extending widthwise between a block position at which to block a passage provided in front of the console box and a retreat position at which the blocking bar retreats from the passage, wherein
a recess is formed at a front end of a lateral side of the console box in which the blocking bar is housed when the blocking bar is positioned at the retreat position.

2. The operating device of a construction machine according to claim 1, wherein a surface of the blocking bar and an external surface of the console box adjacent to the recess are flush when the blocking bar is housed in the recess.

3. The operating device of a construction machine according to claim 1, wherein at least a base end portion of the blocking bar is formed of a hard member, while at least a distal end portion of the blocking bar is formed of a soft member that is more elastically deformable than the hard member.

4. The operating device of a construction machine according to claim 1, wherein:
a guided opening is formed in a widthwise intermediate portion of a lower end of the blocking bar that rests at the block position;
the recess of the console box is provided with a guiding protrusion that tapers from a base end portion to a distal end portion; and
the guiding protrusion is inserted into the guided opening when the blocking bar is swung from the block position to the retreat position, thereby forcing a widthwise position of the blocking bar.

5. The operating device of a construction machine according to claim 1, wherein a surface that slopes down outward widthwise when the blocking bar rests at the block position is formed at the distal end portion of the blocking bar.

6. The operating device of a construction machine according to claim 1, wherein the console box is provided with a manual knob for swinging the blocking bar between the block position and the retreat position, and a means for decelerating the blocking bar immediately before the retreat position while the blocking bar is being swung by the manual knob from the block position toward the retreat position.
